(19) United States
(12) Patent Application Publication
(10) Pub. No.: US 2024/0404237 A1
(43) Pub. Date: Dec. 5, 2024

(54) MEDICAL INFORMATION PROCESSING APPARATUS, METHOD AND STORAGE MEDIUM

(71) Applicant: Canon Medical Systems Corporation, Otawara-shi (JP)

(72) Inventors: Haruka KUNEZAKI, Utsunomiya (JP); Takahiko NISHIOKA, Otawara (JP); Kyoko WATANABE, Nasushiobara (JP)

(73) Assignee: Canon Medical Systems Corporation, Otawara-shi (JP)

(21) Appl. No.: 18/678,345

(22) Filed: May 30, 2024

(30) Foreign Application Priority Data
Jun. 2, 2023 (JP) 2023-091776

(51) Int. Cl. G06V 10/26; G06V 10/70; G06V 10/94

(52) U.S. Cl. CPC G06V 10/26; G06V 10/70; G06V 10/945; G06V 2201/03

(57) ABSTRACT

A medical information processing apparatus includes processing circuitry. The processing circuitry being configured to: compute a probability of correspondence to a specific extraction target with respect to each of areas on a medical image, in regard to each of kinds of extraction targets; acquire a plurality of thresholds that are set for the respective kinds of the extraction targets, and determine whether the area corresponds to the extraction target, based on the threshold and the probability, in regard to each of the areas and in regard to each of the kinds of the extraction targets; and adjust the threshold in accordance with an input of the threshold.

### CROSS-REFERENCE TO RELATED APPLICATION

This application is based upon and claims the benefit of priority from prior Japanese Patent Application No. 2023-091776, filed Jun. 2, 2023, the entire contents of which are incorporated herein by reference.

### FIELD

Embodiments described herein relate generally to a medical information processing apparatus, a method and a storage medium.

### BACKGROUND

With the development of deep learning technology, segmentation of a plurality of internal organs is performed for one medical image acquired by an examination, and a three-dimensional image is generated by using the segmentation result, or the segmentation result is used for clinical analysis.

In connection with the above technology, as a method of performing segmentation of internal organs from one medical image, there is known a method in which mask images of internal organs are generated by using a plurality of deep learning (DL) inferrers that extract areas of specific kinds of internal organs from a medical image, and the mask images are superimposed on one medical image. If areas masked in the DL inferrers overlap, there is a case where the areas of internal organs overlap. In a case where the areas of internal organs overlap, there arises such a problem that the segmentation cannot accurately be performed.

### BRIEF DESCRIPTION OF THE DRAWINGS

FIG. 1 is a diagram illustrating an example of a configuration of a medical information processing apparatus according to a first embodiment.

FIG. 2 is a flowchart exemplarily illustrating a processing procedure of a segmentation support process by the medical information processing apparatus according to the first embodiment.

FIG. 3 is a diagram illustrating an example of a display screen displayed by the medical information processing apparatus according to the first embodiment.

FIG. 4 is a diagram illustrating an example of a display screen displayed by a medical information processing apparatus according to a second embodiment.

FIG. 5 is a diagram illustrating an example of a display screen displayed by a medical information processing apparatus according to a first modification of the second embodiment.

FIG. 6 is a diagram illustrating an example of a display screen displayed by a medical information processing apparatus according to a second modification of the second embodiment.

FIG. 7 is a diagram illustrating an example of a display screen displayed by a medical information processing apparatus according to a third modification of the second embodiment.

FIG. 8 is a diagram illustrating an example of a change of an area D of FIG. 7.

FIG. 9 is a diagram illustrating an example of an overlapping range display part displayed by a medical information processing apparatus according to another modification of the embodiment.

FIG. 10 is a diagram illustrating an example of an overlapping range display part displayed by a medical information processing apparatus according to another modification of the embodiment.

FIG. 11 is a diagram illustrating an example of an overlapping range display part displayed by a medical information processing apparatus according to another modification of the embodiment.

FIG. 12 is a diagram illustrating an example of an overlapping range display part displayed by a medical information processing apparatus according to another modification of the embodiment.

FIG. 13 is a diagram illustrating an example of an overlapping range display part displayed by a medical information processing apparatus according to another modification of the embodiment.

### DETAILED DESCRIPTION

In general, according to one embodiment, a medical information processing apparatus includes processing circuitry. The processing circuitry being configured to: compute a probability of correspondence to a specific extraction target with respect to each of areas on a medical image, in regard to each of kinds of extraction targets; acquire a plurality of thresholds that are set for the respective kinds of the extraction targets, and determine whether the area corresponds to the extraction target, based on the threshold and the probability, in regard to each of the areas and in regard to each of the kinds of the extraction targets; and adjust the threshold in accordance with an input of the threshold.

Hereinafter, referring to the accompanying drawings, embodiments of a medical information processing apparatus, a method and a storage medium are described in detail. In the description below, structural elements having substantially identical functions and structures are denoted by identical reference signs, and an overlapping description is given only where necessary.

### First Embodiment

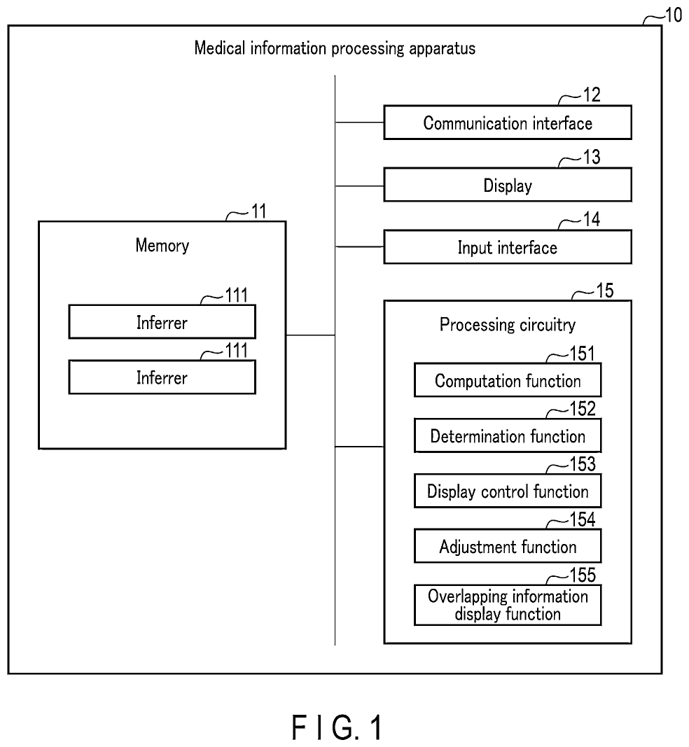

FIG. 1 is a diagram illustrating a configuration of a medical information processing apparatus 10. The medical information processing apparatus 10 is connected via a network to an external system such as a hospital information system (HIS) or a radiological information system (RIS), or to external equipment such as a medical image diagnosis apparatus. The medical information processing apparatus 10 can transmit and receive, via the network, information, such as medical images, to and from the external system or external equipment. The medical image diagnosis apparatus is, for example, a modality that photographs the inside of a subject, such as a computed tomography (CT) apparatus, a magnetic resonance imaging (MRI) apparatus, an ultrasonic diagnosis apparatus, an X-ray diagnosis apparatus, or the like. The network is, for example, a local area network (LANl). Note that the connection to the network may be either a wired connection or a wireless connection. In addition, if security is ensured by a virtual private network (VPN) or the like, the connected network is not limited to the LAN. A connection to a public communication network, such as the internet, may be available.

The medical information processing apparatus 10 includes a memory 11, a communication interface 12, a display 13, an input interface 14 and processing circuitry 15. Hereinafter, although the medical information processing apparatus 10 is described as executing a plurality of functions by a single apparatus, the functions may be executed by different apparatuses. For example, the functions that the medical information processing apparatus 10 executes may be distributedly implemented in different console apparatuses or workstation apparatuses.

The memory 11 is a storage device such as a hard disk drive (HDD), a solid state drive (SSD), an integrated circuit, or the like. In addition, aside from the HDD, SSD or the like, the memory 11 may be a portable storage medium such as a compact disc (CD), a digital versatile disc (DVD), or a flash memory. Note that the memory 11 may be a drive device that reads and writes various information from and to a semiconductor memory device or the like, such a flash memory, or a random access memory (RAN). Besides, a storage area of the memory 11 may be provided in the medical information processing apparatus 10, or may be provided in an external storage device connected via a network.

The memory 11 stores a program executed by the processing circuitry 15, and various data or the like used in the processing of the processing circuitry 15. As the program, for example, use is made of a program that is preinstalled in a computer from a network or a non-transitory computer-readable storage medium, and causes the computer to implement the functions of the processing circuitry 15. In addition, the memory 11 stores medical images, medical data, trained models, or the like, which are used in various processes. Note that the various data treated in the present specification is typically digital data. The memory 11 is an example of a storage unit.

The communication interface 12 is a network interface that executes transmission control of communication with the external system or external equipment via the network.

The display 13 displays various information. For example, the display 13 outputs medical information generated by the processing circuitry 15, and a graphical user interface (GUI) for accepting various operations from an operator. For example, the display 13 is a liquid crystal display or a cathode-ray tube (CRT). The display 13 is an example of a display unit.

The input interface 14 accepts various input operations from the operator, converts an accepted input operation into an electric signal, and outputs the electric signal to the processing circuitry 15. For example, the input interface 14 accepts an input of medical information and an input of various command signals from the operator. The input interface 14 is implemented by a mouse, a keyboard, a trackball, a switch button, a touch screen in which a display screen and a touch pad are integrated, non-contact input circuitry using an optical sensor, and audio input circuitry, which are designed for executing various processes or the like of the processing circuitry 15. The input interface 14 is connected to the processing circuitry 15, converts an input operation received from the operator into an electric signal, and outputs the electric signal to the processing circuitry 15. Note that in the present specification, the input interface is not limited to an input interface including a physical operational component such as a mouse or a keyboard. Examples of the input interface include electric signal processing circuitry that receives an electric signal corresponding to an input operation from an external input device provided separately from the apparatus, and outputs the electric signal to the processing circuitry 15. The input interface 14 is an example of an input unit.

The processing circuitry 15 controls an operation of the entirety of the medical information processing apparatus 10. The processing circuitry 15 is a processor that executes a computation function 151, a determination function 152, a display control function 153, an adjustment function 154 and the overlapping information display function 155 by calling and executing the program in the memory 11.

Note that the term “processor” used in the above description means, for example, a central processing unit (CPU), a graphics processing unit (GPU), or circuitry such as an application specific integrated circuit (ASIC) or a programmable logic device (for example, simple programmable logic device (SPLD), a complex programmable logic device (CPLD) or a field programmable gate array (FPGA)). If the processor is, for example, a CPU, the processor implements the functions by reading and executing the program stored in the storage circuitry. On the other hand, if the processor is, for example, an ASIC, the functions are directly incorporated in the circuitry of the processor as logic circuitry, instead of the program being stored in the storage circuitry. Note that, aside from the case where each of the processors of the embodiment is constructed as single circuitry for each processer, a plurality of independent circuitries may be combined to constitute a single processor, thereby implementing the functions thereof. Furthermore, a plurality of structural elements in FIG. 1 may be integrated into a single processor, thereby implementing the functions thereof. The above description of the “processor” similarly applies to embodiments and modifications below.

Note that in FIG. 1, the computation function 151, determination function 152, display control function 153, adjustment function 154 and the overlapping information display function 155 are described as being implemented by the single processing circuitry 15. However, a plurality of independent processors may be combined to constitute processing circuitry, and each processor may implement each function by executing the program. In addition, the computation function 151, determination function 152, display control function 153, adjustment function 154 and the overlapping information display function 155 may be implemented as individual hardware circuitries. The above description of the functions that the processing circuitry 15 executes is similarly applicable to embodiments and modifications to be described below.

In addition, although the medical information processing apparatus 10 is described as executing a plurality of functions by a single console, the functions may be executed by different apparatuses. For example, the functions of the processing circuitry 15 may be distributedly implemented in different apparatuses.

By the computation function 151, the processing circuitry 15 computes a probability of correspondence to a specific tissue with respect to each of areas of a medical image, in regard to each of kinds of tissues. The processing circuitry 15 that implements the computation function 151 is an example of a computation unit. The tissue is an example of an extraction target.

The medical image is, for example, an image that is photographed in an examination using a medical image diagnosis apparatus. For example, the medical image is a CT image including a plurality of tissues. The tissues included in the medical image are internal organs in the body, and are, for example, a bone, a blood vessel, the liver, the lungs, the large intestine, and the heart. The areas of the medical image are areas into which the medical image is divided. The area may be, for example, areas into the medical image is divided in units of one pixel, may be areas into which the medical image is divided in units of a plurality of pixels, or may be areas into which the medical image is divided based on a specific condition.

As the probability of correspondence to the specific tissue, an existence probability of a tissue, for example, can be used. The existence probability has, for example, a value in a range of 0 to 1, and the value indicates a higher possibility of correspondence to the tissue as the value becomes greater. In the computation function 151, the processing circuitry 15 computes the existence probability of a tissue, in regard to each of the kinds of tissues and in regard to each of the areas, and generates a probability map of each tissue.

In the computation function 151, the processing circuitry 15 computes the existence probabilities of tissues in accordance with the inferrers 111. The inferrer 111 is a trained machine learning model (hereinafter referred to as “trained model”). The number of inferrers 111 that are prepared corresponds to the number of kinds of tissues, for which segmentation is performed, and the inferrers 111 are stored in the memory 11. The inferrer 111 is trained in such a manner as to accept an input of a medical image and to output the probability of correspondence to a specific tissue in regard to each of areas of the input medical image. For example, the inferrer 111 is formed in such a manner as to learn segmentation results of an internal organ and to output the existence probability of the internal organ at each location in the medical image. As the trained model, for example, a DL (Deep Learning) inferrer can be used. The processing circuitry 15 inputs a medical image, for which segmentation is performed, to the inferrer 111, and causes the trained model to output the probability that each area in the medical image corresponds to a specific tissue.

For example, in a case where segmentation of “bone” and “blood vessel” is performed for a CT image, two trained models are pretrained, one being a trained model that outputs, in regard to each pixel, the probability that the input CT image is “bone”, the other being a trained model that outputs, in regard to each pixel, the probability that the input CT image is “blood vessel”. For example, at a time of training the trained model that outputs the existence probability of “bone” in the CT image, the machine learning model is caused to learn teaching data including a plurality of pairs each being a pair between a CT image and a probability map indicating an existence probability of “bone” at each pixel.

By the determination function 152, the processing circuitry 15 acquires a plurality of thresholds that are set for respective kinds of tissues, and determines, in regard to each area of the medical image and in regard to each kind of tissue, whether the area corresponds to the tissue, based on the threshold and the existence probability. At this time, the processing circuit 15 compares the threshold and the existence probability with respect to each specific area of the medical image, and determines whether this area corresponds to the tissue. Further, by repeating the determination for a plurality of tissues, the processing circuitry 15 determines, in regard to each of the kinds of tissues, whether each area of the medical image corresponds to the tissue. The processing circuitry 15 that implements the determination function 152 is an example of a determination unit.

By the display control function 153, the processing circuitry 15 causes the display 13 to display various information. For example, the processing circuitry 15 causes the display 13 to display a medical image, information relating to a patient of the medical image, and an interface for executing various operations.

In addition, by the display control function 153, the processing circuitry 15 causes the display 13 to display, based on the determination result of each area of the medical image, a superimposition image in which a layer representing an area of a tissue is superimposed on the medical image. The layer is, for example, a mask image in which a specific color is added to an area corresponding to an associated tissue. Typically, a semitransparent mask image is used as the layer. For example, the processing circuitry 15 extracts a plurality of internal organ areas from a medical image by using a determination result relating to a plurality of internal organs, generates a mask image of each internal organ, based on the extraction result, and superimposedly displays the generated mask images on one medical image. The processing circuitry 15 that implements the display control function 153 is an example of a display control unit.

In accordance with an input of a threshold of a tissue of an adjustment target, the processing circuitry 15 adjusts the threshold by the adjustment function 154. At this time, the processing circuitry 15 changes the threshold of the tissue of the adjustment target from a current value to an input value. The tissue of the adjustment target may be one kind of tissue, or two or more kinds of tissues. In addition, the tissue of the adjustment target may be preset, or may be selected by the user. The processing circuitry 15 that implements the adjustment function 154 is an example of an adjustment unit.

Additionally, by the adjustment function 154, the processing circuit 15 causes the display 13 to display an input part that accepts an input of a threshold. The input part is, for example, a slider bar. By operating the slider bar, the user can adjust the threshold for each tissue to a freely selected value. Note that, in place of the slider bar, an input part that can directly input a freely selected value as the threshold may be displayed.

Besides, by the adjustment function 154, the processing circuit 15 updates, in accordance with the adjustment of the threshold by the operation of the input part, the determination result of each area of the medical image, and updates the corresponding layer on the medical image in accordance with the update of the determination result. For example, by using the updated determination result, the processing circuitry 15 re-extracts an internal organ area relating to a specific internal organ from the medical image, re-generates the mask image by using the extraction result, inserts the re-generated mask into the corresponding layer, and renders the medical image, thereby updating the superimposition image.

Additionally, by the overlapping information display function 155, the processing circuitry 15 specifies an overlapping area in which overlap occurs in a case of changing the threshold of the tissue of the adjustment target, and a range of values (hereinafter referred to as “overlapping occurrence range”) within which the overlapping area occurs in the case of changing the threshold. The overlapping area is an area that is determined to correspond to both the tissue of the adjustment target and another tissue. In a case where a plurality of tissues of adjustment targets are set, the processing circuitry 15 specifies the overlapping occurrence range for each of the tissues of the adjustment targets. The processing circuitry 15 that implements the overlapping information display function 155 is an example of an overlapping information display unit.

For example, in a case where current thresholds of “bone” and “blood vessel” are 0.5 and the threshold of “bone” is adjusted, in an area in which the existence probability of “blood vessel” is 0.5 or more, if the threshold of “bone” becomes smaller than the existence probability of “bone”, an overlapping area corresponding to both “blood vessel” and “bone” occurs. Thus, in the area in which the existence probability of “blood vessel” is equal to or greater than 0.5 that is the current threshold, if the threshold of “bone” becomes smaller than a maximum value of the existence probability of “bone”, an overlapping area occurs. In other words, in the area where the existence probability of “blood vessel” is the current threshold or more, a value smaller than the maximum value of the existence probability of “bone” becomes the overlapping occurrence range relating to “bone”.

Additionally, by the overlapping information display function 155, the processing circuitry 15 causes the display 13 to display information relating to the overlapping area. For example, the processing circuitry 15 causes an adjustment part to display an overlapping occurrence range by changing a background color of a position corresponding to the overlapping occurrence range on an adjustment bar.

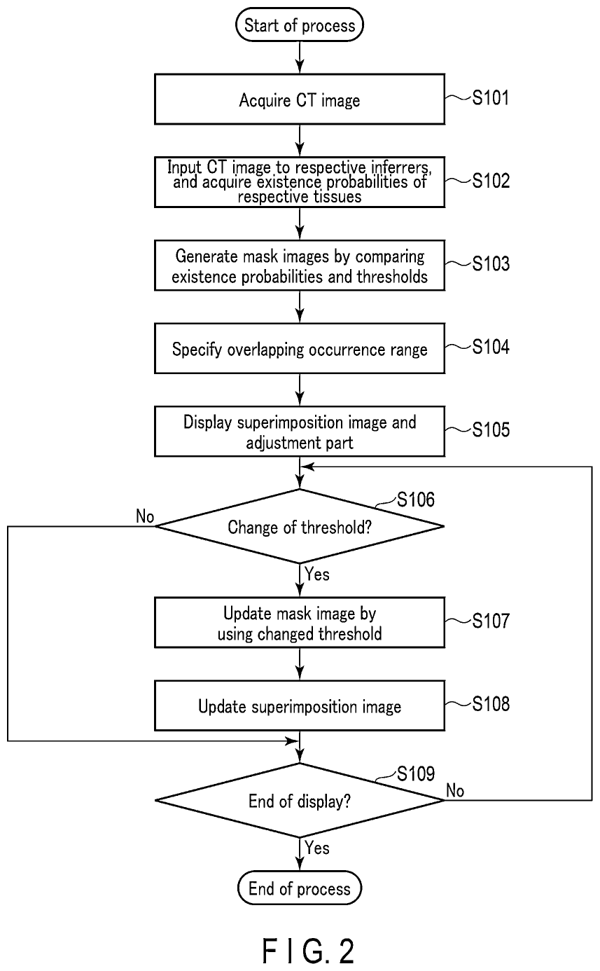

Next, a description is given of an operation of a segmentation support process that is executed by the medical information processing apparatus 10. FIG. 2 is a flowchart exemplarily illustrating a processing procedure of the segmentation support process. Here, a description is given of, by way of example, a case where two inferrers are used as the inferrers 111, namely a first inferrer that outputs, in regard to each pixel, an existence probability of correspondence to “bone” in an input CT image, and a second inferrer that outputs, in regard to each pixel, an existence probability of correspondence to “blood vessel” in the input CT image, and segmentation is performed for “bone” and “blood vessel” in the CT image. The medical information processing apparatus 10 generates a mask image of the bone and a mask image of the blood vessel by comparing the existence probabilities that are output from the first inferrer and second inferrer with thresholds thereof, and superimposedly displays the mask image of the bone and the mask image of the blood vessel on one CT image. The CT image is an example of the medical image, each pixel is an example of each area in the medical image, and “bone” and “blood vessel” are examples of the kinds of tissues. In addition, as the tissues of the adjustment targets, both the “bone” and “blood vessel” are set.

Note that processing procedures in the processes to be described below are merely examples, and each process can be appropriately modified as much as possible. In addition, in the processing procedures to be described below, omission, replacement and addition of steps can be made as appropriate, in accordance with modes of implementation.

### (Step S101)

To begin with, in a segmentation support process, the processing circuitry 15 acquires a CT image for which segmentation is performed, by the computation function 151. The CT image may be prestored in the memory 11, or may be acquired from an external system, or may be input by the user.

### (Step S102)

Next, by the computation function 151, the processing circuitry 15 inputs the acquired CT image to each of the first inferrer and second inferrer. The first inferrer accepts the input of the CT image, and outputs an existence probability of “bone” at each pixel. The second inferrer accepts the input of the CT image, and outputs an existence probability of “blood vessel” at each pixel.

### (Step S103)

Subsequently, by the determination function 152, the processing circuitry 15 compares the existence probability of “bone”, which is output from the first inferrer, with the threshold of “bone”, and determines the correspondence or noncorrespondence to “bone” in regard to each pixel, and also compares the existence probability of “blood vessel”, which is output from the second inferrer, with the threshold of “blood vessel”, and determines the correspondence or noncorrespondence to “blood vessel” in regard to each pixel. The threshold of “bone” and the threshold of “blood vessel” are automatically set at predetermined default values. Here, a value “0.5” is used as the predetermined default value. The processing circuitry 15 determines that a pixel, at which the existence probability of “bone” is 0.5 or more, corresponds to “bone”, and determines that a pixel, at which the existence probability of “blood vessel” is 0.5 or more, corresponds to “blood vessel”. Thereafter, based on the determination results, the processing circuitry 15 generates a first mask image that masks the pixel corresponding to “bone”, and a second mask image that masks the pixel corresponding to “blood vessel”.

### (Step S104)

Next, by the overlapping information display function 155, the processing circuitry 15 specifies an overlapping occurrence range with respect to each of the “bone” and “blood vessel” which are tissues of adjustment targets. At this time, the processing circuitry 15 specifies, with respect to “bone”, an overlapping occurrence range in which an overlapping area with “blood vessel” occurs, and specifies, with respect to “blood vessel”, an overlapping occurrence range in which an overlapping area with “bone” occurs.

### (Step S105)

Next, by the display control function 153 and overlapping information display function 155, the processing circuitry 15 causes the display 13 to display a superimposition image in which the first mask image and second mask image are superimposed on the CT image, and an adjustment part for adjusting the thresholds of the tissues of the adjustment targets.

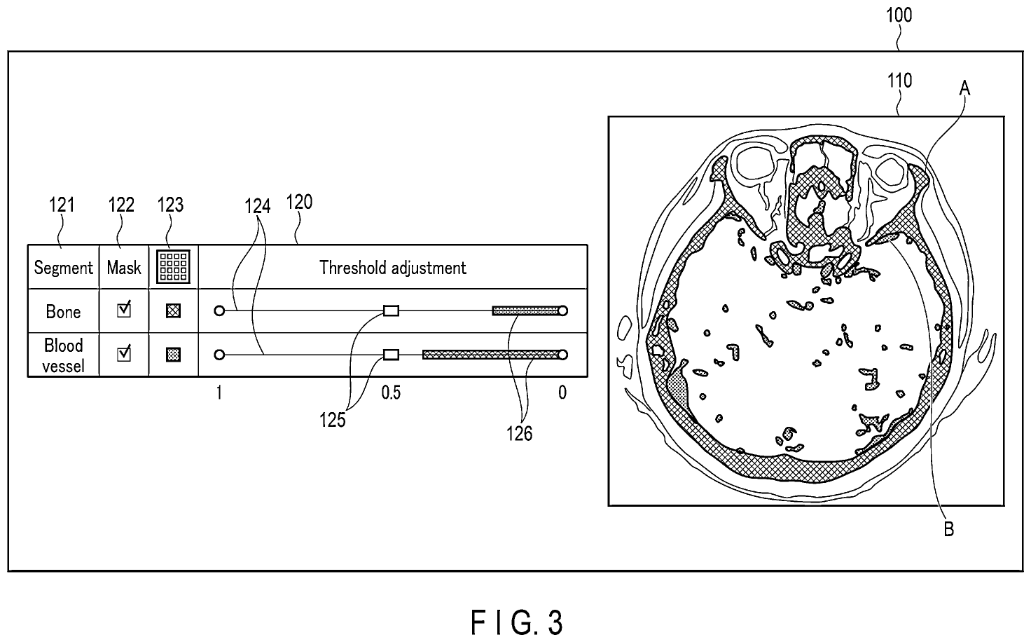

FIG. 3 is a diagram illustrating an example of a display screen 100 displayed on the display 13. In the example of FIG. 3, the display screen 100 displays an image display part 110 and an adjustment part 120. The CT image is displayed on the image display part 110, and the first mask image and second mask image are superimposedly displayed on the CT image. In FIG. 3, the second mask image is superimposed on the CT image, and the first mask image is superimposed thereon. A mask area A of the first mask image and a mask area B of the second mask image are displayed in different colors. For example, the mask area A is displayed in green, and the mask area B is displayed in blue.

Adjustment bars for adjusting the thresholds of the respective tissues are displayed in the adjustment part 120. The adjustment part 120 includes a tissue name display portion 121, a display selector 122, a display color selector 123, slider bars 125, and overlapping range display portions 126.

The tissue name display portion 121 displays the names of kinds of tissues for which segmentation is performed. In the display selector 122, whether or not to display each mask image on the CT image can be selected in regard to each of the kinds of tissues. For example, a check mark is displayed in a check box of the tissue, the mask image of which is displayed. If the check box is selected in the display selector 122, the mask image of the corresponding tissue is superimposedly displayed on the CT image that is displayed in the image display part 110. In the display color selector 123, the color of the mask image displayed on the image display part 110 can be selected in regard to each of the kinds of tissues.

The slider bar 125 is provided in regard to each of the kinds of tissues in order to adjust the threshold, and the slider bar 125 is displayed on a scale 124 indicating the threshold. The slider bar 125 is displayed at a position corresponding to the current threshold, and is movable in a range of 0 to 1. It is preferable that the range of movement of the slider bar 125 is not limited to the range of 0 to 1, and is appropriately adjusted in accordance with various conditions.

The overlapping range display portion 126 is provided in regard to each of the kinds of tissues, and indicates the occurrence of an overlapping area with some other tissue. The overlapping range display portion 126 is displayed at a position corresponding to an overlapping occurrence range on the scale 124. For example, at a position corresponding to “bone” on the scale 124, the overlapping range display portion 126 is displayed in a color corresponding to “blood vessel” in the range in which an overlapping area with “blood vessel” occurs. At a position corresponding to “blood vessel” on the scale 124, the overlapping range display portion 126 is displayed in a color corresponding to “bone” in the range in which an overlapping area with “bone” occurs. By confirming the overlapping range display portion 126, the user can easily understand the range in which an overlapping area with the other tissue occurs, and can adjust the threshold of the tissue of the adjustment target to such a threshold that no overlapping area does occurs.

### (Step S106)

Next, by the adjustment function 154, the processing circuitry 15 detects a change of the threshold by an operation of the slider bar 125.

### (Step S107)

If the slider bar 125 is operated by the user and the threshold of “bone” or “blood vessel” is changed (Step S106-Yes), the processing circuitry 15, by the adjustment function 154, redetermines, in regard to the tissue, the threshold of which was changed, the correspondence or noncorrespondence to the tissue by using the changed threshold and existence probability, and regenerates a mask image by using the redetermination result, thereby updating the mask image of the tissue, the threshold of which was changed.

### (Step S108)

By the adjustment function 154, the processing circuitry 15 updates the superimposition image by superimposedly displaying the updated mask image on the CT image.

For example, if the threshold of “bone” is changed to a greater value than the current value, the number of pixels that are determined to correspond to the tissue decreases, and a masked part in the first mask image decreases. On the other hand, if the threshold of “bone” is changed to a smaller value than the current value, the number of pixels that are determined to correspond to the tissue increases, and a masked part in the first mask image increases.

### (Step S109)

The processing circuitry 15 detects an operation for terminating the segmentation support process, and repeatedly executes the process of step S106 to step S108 until this operation is executed (step S109-No), and updates the display image each time the threshold is changed. If the operation for terminating the segmentation support process is executed (step S109-Yes), the processing circuitry 15 terminates the segmentation support process.

Hereinafter, advantageous effects of the medical information processing apparatus 10 according to the present embodiment are described.

The medical information processing apparatus 10 according to the present embodiment can compute a probability that each of areas on a medical image corresponds to a specific tissue, in regard to each of kinds of tissues, can acquire a plurality of thresholds that are set for the respective kinds of tissues, and can determine whether the area corresponds to the tissue, based on the threshold and an existence probability, in regard to each of the areas on the medical image and in regard to each of the kinds of tissues. In addition, the medical information processing apparatus 10 can adjust the threshold of the tissue in accordance with an input of the threshold.

The medical image is, for example, a medical image generated by a medical image diagnosis apparatus, such as a CT image, an X-ray image or an ultrasonic image. Each area on the medical image may be, for example, an area of one pixel, an area of a plurality of pixels, or an area divided in advance, based on a freely selected condition. The kind of tissue is, for example, the kind of an internal organ. The kinds of internal organs are, for example, “bone”, “blood vessel”, “lungs” and “liver”. The probability of correspondence to the specific tissue is, for example, an existence probability. Data including the existence probability in each area on the medical image may be called “probability map”.

By the above-described configuration, according to the medical information processing apparatus 10 of the present embodiment, by adjusting the threshold that is set for each of tissues to a freely selected value, the user adjusts the determination condition in segmentation and performs segmentation by using a desired determination condition, and thus can perform accurate segmentation by taking an overlap between tissues into account.

Additionally, the medical information processing apparatus 10 of the present embodiment can cause the display to display, based on the determination result of each area of the medical image, a superimposition image in which the mask image representing the area of the tissue is superimposed as a layer on the medical image, can cause the display 13 to display the input part that accepts an input of the threshold, can update the determination result in accordance with the adjustment of the threshold by the operation of the input part, and can update the display of the layer in accordance with the update of the determination result. For example, the mask image is generated based on the determination result in regard to each of the kinds of tissues, and the mask image of each tissue is superimposedly displayed on the medical image. In addition, as the adjustment part, the scales 124 and slider bars 125 illustrated in FIG. 3 are displayed. By moving the slider bar 125, the user can adjust the threshold of the tissue to a freely selected value. Each time the threshold of the tissue is changed by the user, the determination result of the tissue, the threshold of which is changed, and the mask image are updated, and the updated mask image is displayed on the medical image. Thus, on the medical image, the part masked by the mask image is updated in accordance with the change of the threshold. For example, if the threshold of “bone” is changed to a greater value than the current value, the number of pixels that are determined to correspond to the tissue decreases, and the part masked as “bone” decreases. On the other hand, if the threshold of “bone” is changed to a smaller value than the current value, the number of pixels that are determined to correspond to the tissue increases, and the part masked as “bone” increases. By confirming the variation of a segmentation image while changing the threshold, the user can easily adjust the determination condition that is used for the segmentation, in such a manner as to be able to acquire a discretionary segmentation result.

For example, in a case where there is a pixel at which the existence probability of “bone” is greater than the current threshold and the existence probability of “blood vessel” is greater than the current threshold, this pixel becomes an overlapping area that corresponds to both of the “bone” and “blood vessel”. The user adjusts the threshold while confirming the variation of the overlapping area, and, by adjusting the threshold such that no overlapping area occurs, the user can acquire a result of the segmentation performed under the condition that no overlapping area occurs. For example, the threshold of “bone” is changed to a value greater than the maximum value of the existence probability of “bone” in all overlapping areas. Thereby, the threshold of “bone” becomes greater than the existence probability of “bone” in all overlapping areas, and the correspondence to “bone” is not determined in all overlapping areas, and no overlapping area occurs.

Additionally, the medical information processing apparatus 10 according to the present embodiment can accept an input of a medical image, and can compute, in accordance with a trained model, the existence probability of correspondence to a specific tissue in regard to each of areas in the input medical image. Specifically, use is made of a DL inferrer that outputs the existence probability of “bone” at each pixel of the input medical image, and a DL inferrer that outputs the existence probability of “blood vessel” at each pixel of the input medical image. By using not the mask image of a specific tissue, but the DL inferrer that outputs the existence probability, the threshold that is the determination condition for each tissue can be adjusted, and segmentation with high accuracy can be performed.

Note that the probability map indicating the existence probability of each area may be computed by using a rule-based algorithm. For example, by the computation function 151, the processing circuitry 15 may compute the probability of correspondence to a specific tissue in regard to each of areas in a medical image, based on a luminance value of the medical image. In this case, since the range of the CT value of each tissue in the CT image is already known, the existence probability of each tissue may be computed for each pixel, based on the CT value of the CT image. Alternatively, the existence probability of each tissue may be computed by utilizing a contrast between a CT value and a nearby CT value. Note that some other method may be used if the method is an algorithm of computing the existence probability of a tissue in regard to each of areas in the medical image.

Additionally, if the threshold of the tissue of the adjustment target is greatly changed, even in an area where it is clear from a luminance value that the possibility of correspondence to the tissue is low, there is a case where the correspondence to the tissue is determined. Thus, in the area determined to correspond to the tissue, if the luminance value of the area greatly deviates from a general range, a warning may be issued to the user. In this case, by the adjustment function 154, the processing circuitry 15 acquires a range of general luminance values in the tissue as a reference value, and issues a warning to the user by using display on the display 13 or sound, if a difference between the luminance value of the area determined to correspond to the tissue of the adjustment target and the reference value is a predetermined value or more.

Additionally, since the range of the CT value of “bone” is already known, if an area obviously considered as “bone” from the CT value is determined to be “blood vessel” as a result of the adjustment of the threshold of “blood vessel”, a warning may be issued.

Additionally, the medical information processing apparatus 10 according to the present embodiment can specify an overlapping area corresponding to a plurality of tissues, and can cause the display 13 to display information relating to the overlapping area. Specifically, by specifying the overlapping area while varying the threshold of the tissue of the adjustment target, the medical information processing apparatus 10 specifies an overlapping occurrence range in which an overlapping area occurs if the threshold of the tissue of the adjustment target is varied, and changes the background color of the position corresponding to the overlapping occurrence range on the adjustment bar, as illustrated in FIG. 3. By adjusting the threshold of each tissue while considering the overlapping area, the user can accurately adjust the segmentation areas of a plurality of tissues.

Note that in a case where an overlapping area occurs at a time of setting thresholds of tissues at default values, the thresholds of the tissues may automatically be adjusted so that no overlapping area occurs. In this case, if an overlapping area is specified at a time of setting default values as thresholds, the processing circuitry 15 changes, by the adjustment function 154, the thresholds from the default values in such a manner that no overlapping area occurs. Specifically, in a case where the overlapping occurrence range specified by the overlapping information display function 155 includes a default value of a threshold, the processing circuitry 15 changes, by the adjustment function 154, the threshold to a value that is not included in the overlapping area. For example, in a case where the default value of the threshold of “bone” is 0.5 and it is specified that an overlapping area with “blood vessel” occurs if the threshold of “bone” is 0.6 or less, the threshold of “bone” is automatically changed to a value that is slightly greater than 0.6. Since the medical image is presented in the state in which no overlapping area occurs, the operational load on the user is reduced.

Additionally, in the present embodiment, since the information of existence probabilities of the respective tissues can be utilized, an internal organ with a high existence probability in regard to the overlapping area can be adopted. In this case, in the overlapping area, only the mask image of the tissue with the highest existence probability, among the corresponding tissues, is displayed. In addition, the tissues displayed in the overlapping area may be determined based on a preset priority. In this case, among the tissues corresponding to the overlapping area, the mask image of the tissue with a highest preset priority is displayed in the overlapping area. Thereby, in a case where masks belonging to different layers overlap, a layer of a higher level can be displayed with a higher priority. In addition, it is preferable that the adjustment part 120 in FIG. 3 displays adjustment bars in an order beginning from a highest preset priority. Besides, the setting of the priority may be made manually changeable by the user. For example, it is preferable that the order of tissues displayed on the adjustment part 120 of FIG. 3 can be freely changed by the user.

### Second Embodiment

A second embodiment is described. The present embodiment is a modification of the configuration of the first embodiment, as described below. A description of similar structures, operations and advantageous effects to the first embodiment is omitted. In the first embodiment, the case was described in which the segmentation of two internal organs, “bone” and “blood vessel”, is performed for one medical image. In the present embodiment, segmentation of three internal organs, “liver”, “lung” and “large intestine”, is performed for one medical image. In addition, “liver”, “lung” and “large intestine” are set as tissues of adjustment targets.

In the present embodiment, as the inferrers 111, three inferrers are used, namely a first inferrer that outputs, in regard to each pixel, an existence probability of correspondence to “liver” in an input CT image, a second inferrer that outputs, in regard to each pixel, an existence probability of correspondence to “lung” in the input CT image, and a third inferrer that outputs, in regard to each pixel, an existence probability of correspondence to “large intestine” in the input CT image.

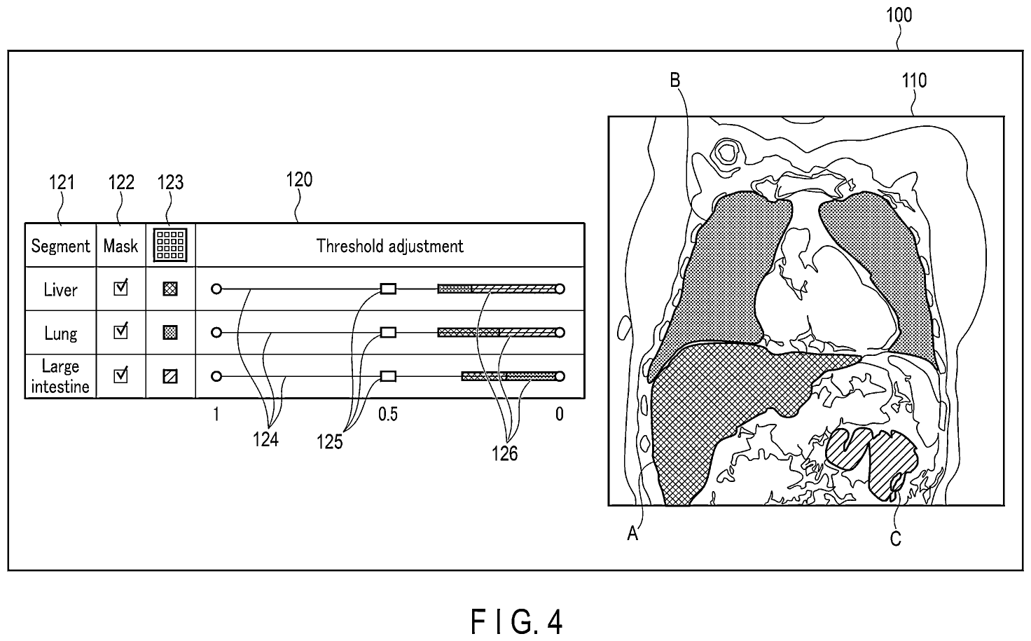

FIG. 4 is a diagram illustrating an example of the display screen 100 displayed on the display 13 in the process of step S105 of the segmentation support process that is executed by the medical information processing apparatus 10 of the present embodiment. In the present embodiment, in the image display part 110, a first mask image masking a pixel corresponding to “liver”, a second mask image masking a pixel corresponding to “lung”, and a third mask image masking a pixel corresponding to “large intestine”, are superimposedly displayed on the CT image. A mask area A of the first mask image, a mask area B of the second mask image and a mask area C of the third mask image are displayed in different colors. For example, the mask area A is displayed in green, the mask area B is displayed in blue, and the mask area C is displayed in red.

In FIG. 4, on the scale 124 of “liver”, in a range in which overlapping areas with “lung” and “large intestine” occur, an overlapping range display portion 126 of corresponding colors is superimposedly displayed. Similarly, on the scales 124 of “lung” and “large intestine”, in ranges in which overlapping areas with other tissues occur, overlapping range display portions 126 of colors corresponding to overlapping tissues are superimposedly displayed. By confirming the overlapping range display portions 126, the user can easily understand the range in which an overlapping area with some other tissue occurs, and can adjust the threshold of the tissue of the adjustment target to such a threshold that no overlapping area occurs.

### First Modification of the Second Embodiment

A first modification of the second embodiment is described. The present modification is a modification of the configuration of the second embodiment, as described below. A description of similar structures, operations and advantageous effects to the second embodiment is omitted.

In the present modification, by the overlapping information display function 155, the processing circuitry 15 re-specifies the overlapping area, each time the threshold of the tissue of the adjustment target changes, and updates the display of the information relating to the overlapping area.

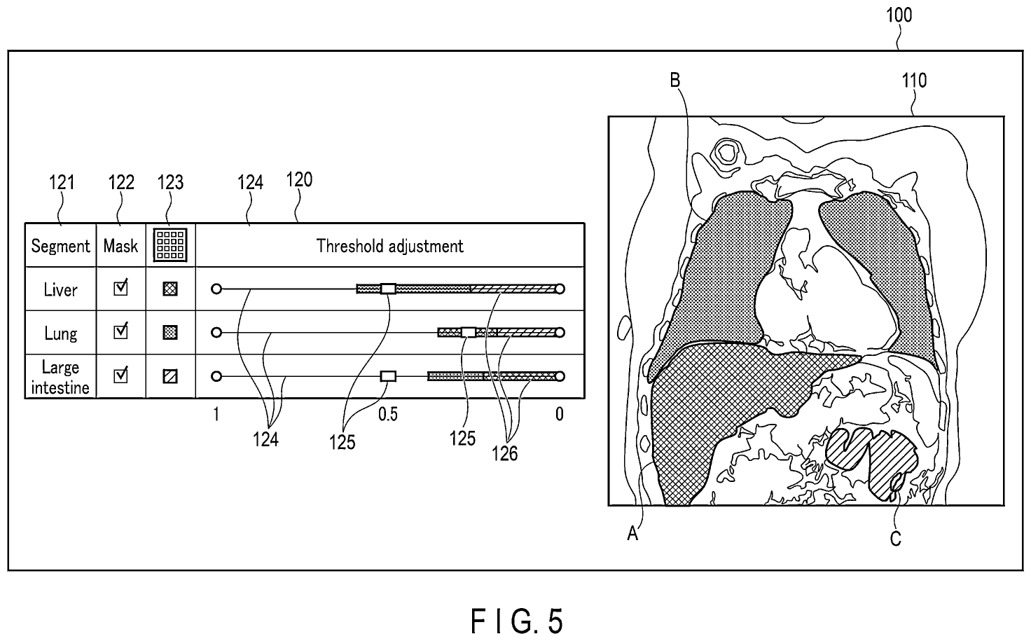

FIG. 5 is a diagram illustrating an example of the display screen 100 in a case where, from the state of FIG. 4 in which the threshold of “lung” is set at 0.5, the slider bar 125 corresponding to “lung” is moved by the user, and the threshold of “lung” is adjusted.

If the slider bar 125 is operated and the threshold of “lung” is changed, the processing circuitry 15 re-specifies, by the overlapping information display function 155, the overlapping area by using the changed threshold of “lung”. For example, as illustrated in FIG. 4 and FIG. 5, if the threshold of “lung” is changed to a smaller value, the range of values determined to correspond to “lung” increases, and the ranges, in which the overlapping areas with “lung” occur if the thresholds of other tissues are changed, increase. Thus, the ranges of display of the overlapping range display portions 126 of “liver” and “large intestine” increase. On the other hand, if the threshold of “lung” is changed to a greater value, the range of values determined to correspond to “lung” decreases, and the ranges, in which the overlapping areas with “lung” occur if the thresholds of other tissues are changed, decrease. Thus, the ranges of display of the overlapping range display portions 126 of “liver” and “large intestine” decrease. While confirming the influence on the range in which the overlapping area occurs due to the adjustment of the threshold of a specific internal organ, the user can adjust the thresholds of a plurality of internal organs.

### Second Modification of the Second Embodiment

A second modification of the second embodiment is described. The present modification is a modification of the configuration of the first modification of the second embodiment, as described below. A description of similar structures, operations and advantageous effects to the second embodiment is omitted.

In the present modification, by the overlapping information display function 155, the processing circuitry 15 causes the display 13 to display, if an overlapping area occurs, the fact that the overlapping area occurs, as information relating to the overlapping area.

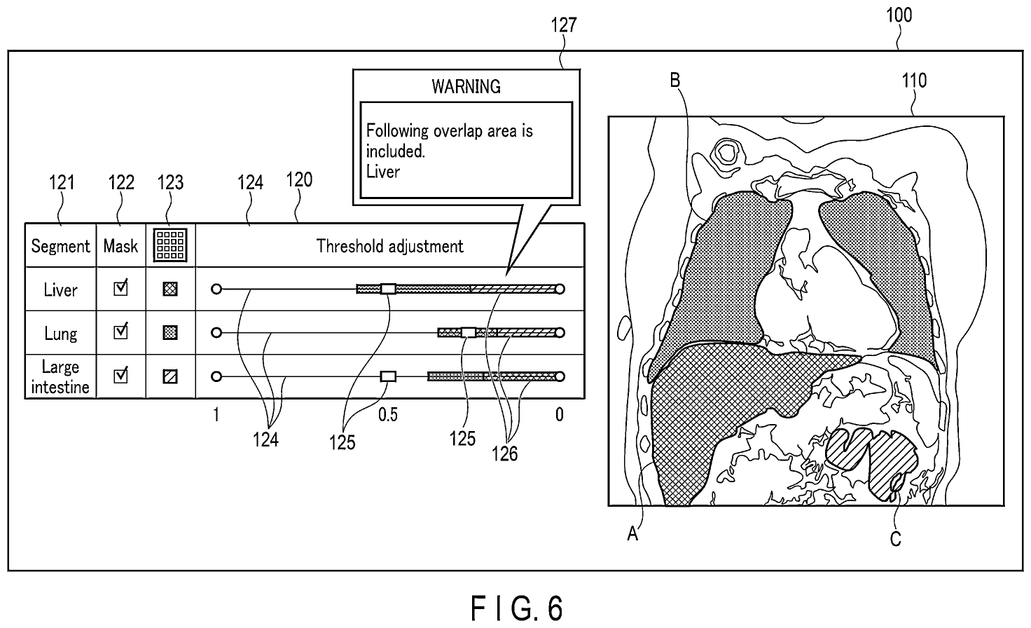

FIG. 6 is a diagram illustrating an example of the display screen 100 that is displayed in a case where the overlapping area occurs. FIG. 6 displays a sentence indicating that an overlapping area with “liver” is included, on the scale 124 of “lung”, because an overlapping area between “lung” and “liver” has occurred by the change of the threshold of “lung” from the state illustrated in FIG. 4. It is possible to notify the user that an overlap with some other tissue has occurred due to the adjustment of the threshold of a specific internal organ, and to prompt the user to adjust the threshold such that no overlap occurs.

### Third Modification of the Second Embodiment

A third modification of the second embodiment is described. The present modification is a modification of the configuration of the second embodiment, as described below. A description of similar structures, operations and advantageous effects to the second embodiment is omitted.

In the present modification, by the overlapping information display function 155, the processing circuitry 15 causes the display 13 to display a selection screen for accepting selection of tissues to be displayed in an overlapping area. At this time, the processing circuitry 15 divides the overlapping area into a plurality of segments, and accepts selection of a tissue to be displayed in regard to each segment.

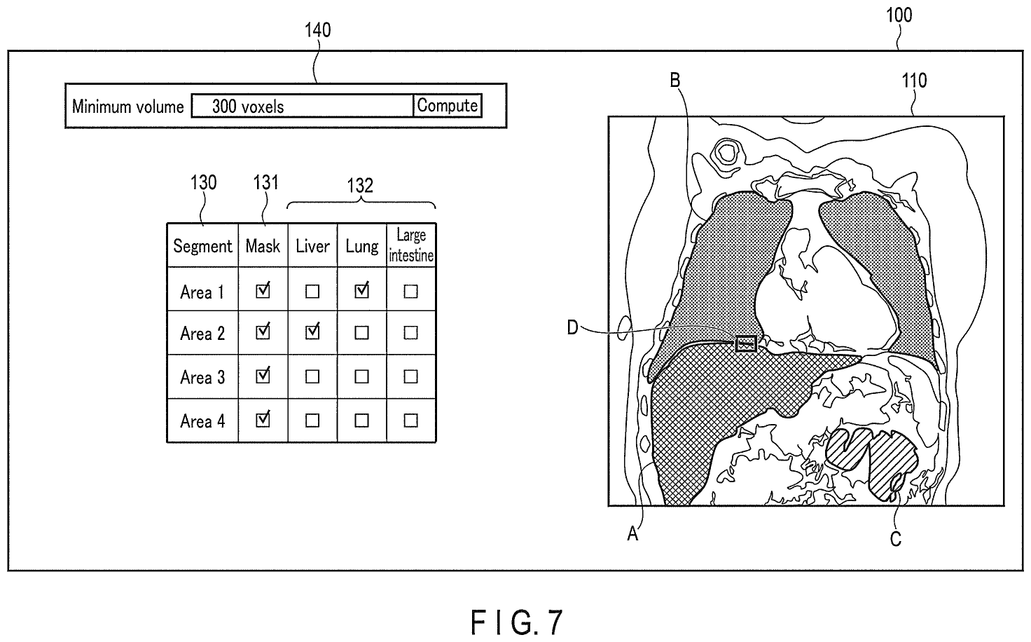

FIG. 7 is a diagram illustrating an example of the display screen 100 that is displayed in a case where an overlapping area between “lung” and “liver” occurs as illustrated in FIG. 5. For example, the display screen 100 illustrated in FIG. 7 is displayed, responding to the user performing, on the display screen of FIG. 5, an operation to display a selection screen for selecting tissues to be displayed in the overlapping area. The overlapping area in the image display part 110 is divided into a plurality of segments, and a tissue, for which a mask image is to be displayed, can be selected in regard to each of the divided segments.

In the example of FIG. 7, the display screen 100 displays an operation input part 130 and a condition input part 140, in place of the adjustment part 120. The operation input part 130 displays, in regard to each of the segments, a check box 131 for selection as to whether or not to display a mask image for each segment, and check boxes 132 for selecting a tissue to be displayed. In FIG. 7, “Area 1”, “Area 2”, “Area 3” and “Area 4” are examples of segment names. If one of the segments is selected by the user, an area on the image display part 110, which corresponds to the selected segment, is displayed with emphasis. FIG. 7 illustrates a case where “Area 2” was selected as the segment.

By operating the presence/absence of a check in the check box 131, the user can execute selection as to whether or not to display a mask image for each segment in the overlapping area. In addition, by selecting the tissue to be displayed in the check box 132, the user can execute selection as to which tissue each segment belongs to, by the user's own judgment, and can perform accurate segmentation.

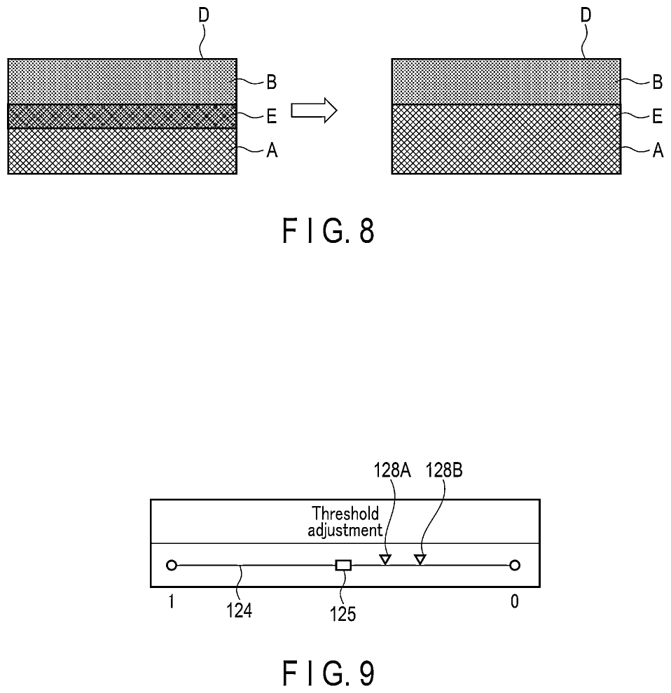

FIG. 8 is a diagram illustrating an example of a change of the image display part 110 in a case where tissues were selected in the check boxes 132. FIG. 8 illustrates a change in an area D of the image display part 110, in a case where “liver” is selected in the check box 132 of “Area 2”. The area D includes the segment of “Area 2” in the overlapping area. An area E in FIG. 8 corresponds to “Area 2”.

A left part of FIG. 8 illustrates a state of the area D before “liver” is selected in the check box 132 of FIG. 7. As illustrated in FIG. 8, in the area E corresponding to “Area 2”, both of the mask image of “lung” and the mask image of “liver” are superimposed.

A right part of FIG. 8 illustrates a state of the area D after “liver” is selected in the check box 132 of FIG. 7. As illustrated in FIG. 8, if “liver” is selected in “Area 2”, only the mask image of “liver” is displayed in the area E corresponding to “Area 2”, and the overlap of the mask images is eliminated.

In addition, in the condition input part 140, a minimum volume can be input as a condition of a segment, in regard to which the selection of a tissue to be displayed is accepted. The minimum volume is a set value for determining a segment in regard to which the user can select a tissue to be displayed. The volume is a volume of a tissue included in the segment. The minimum volume is a minimum value of the volume of the tissue included in the segment to be displayed. The minimum volume can be input, for example, in units of a voxel. The operation input part 130 displays, among a plurality of segments, only a segment including a tissue of a volume that is equal to or greater than the minimum volume that is input in the condition input part 140. Among the segments, in a segment including a tissue of a volume less than the minimum volume, the tissue to be displayed is automatically determined. For example, a tissue with a high existence probability may automatically be determined as the tissue to be displayed. In this case, by the overlapping information display function 155, the processing circuitry 15 accepts the selection by the user of the tissue to be displayed, in regard to the segment including the tissue of the volume equal to or greater than the set value, and displays the tissue with the high existence probability, in regard to the segment including the tissue of the volume less than the set value. Alternatively, a tissue having a high preset priority may automatically be determined as the tissue of the overlapping area. In this case, by the overlapping information display function 155, the processing circuitry 15 accepts the selection by the user of the tissue to be displayed, in regard to the segment including the tissue of the volume equal to or greater than the set value, and displays the tissue having the high preset priority on the overlapping area, in regard to the segment including the tissue of the volume less than the set value. The user discriminates the tissue by himself/herself only with respect to the important area including the tissue of a large volume, and can omit the discrimination of the tissue with respect to an unimportant area including a tissue of a small volume, and therefore the user can perform segmentation accurately and efficiently.

### (Other Modifications)

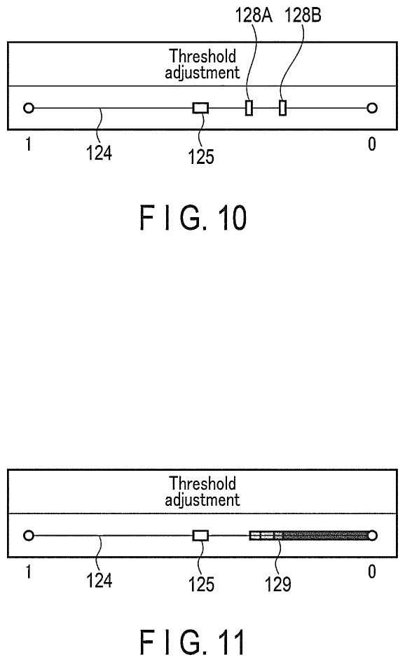

In the above-described embodiments, the example was described in which, as the overlapping range display portion 126, the color corresponding to the overlapping tissue is displayed in the overlapping occurrence range on the scale 124, but the overlapping occurrence range may be displayed by other methods. For example, as illustrated in FIG. 9 and FIG. 10, in place of the overlapping range display portion 126 of FIG. 4, a mark 128A indicating a value at which an overlap with “lung” occurs, and a mark 128B indicating a value at which an overlap with “large intestine” occurs, may be displayed on the scale 124 of “liver”. If the user moves the slider bar 125 of “liver” to a position of a value smaller than the value of the mark 128A, the user can understand that an overlapping area with the “lung” tissue occurs. If the user moves the slider bar 125 of “liver” to a position of a value smaller than the value of the mark 128B, the user can understand that an overlapping area with the “large intestine” occurs, in addition to the occurrence of the overlapping area with “lung”. In addition, by making the colors of the marks 128A and 128B correspond to the colors of the mask images of the overlapping tissues, it may become possible to easily understand which tissue is overlapping.

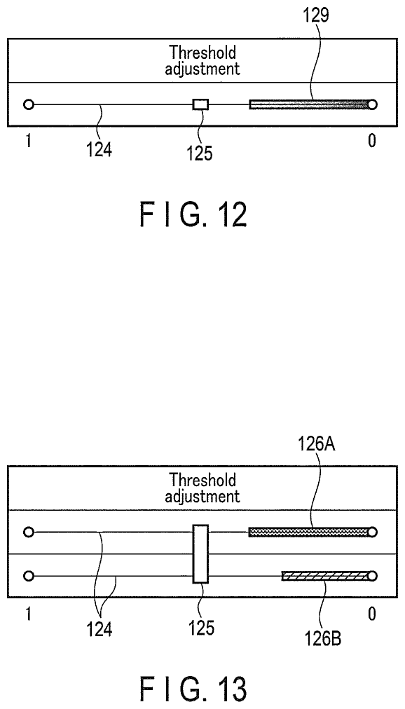

Additionally, as illustrated in FIG. 11 and FIG. 12, the display method of the overlapping range display portion 126 may be changed in accordance with the number of overlapping tissues, instead of the kinds of overlapping tissues. In FIG. 11 and FIG. 12, the overlapping range display portion 126 is displayed in colors that become deeper as the number of overlapping tissues increases. In FIG. 11, the depth of the background color varies stepwise in accordance with the number of overlapping tissues, and in FIG. 12, the depth of the background color varies with use of gradations.

Additionally, in FIG. 4, in the case where the overlapping areas occur in regard to a plurality of tissues, the overlapping range display portions 126 for the respective tissues are superimposedly displayed, but may be separately displayed. For example, as illustrated in FIG. 13, it is possible to separately display, in regard to “liver”, an overlapping range display portion 126A that displays the background of the overlapping occurrence range with “lung” in a color corresponding to “lung”, and an overlapping range display portion 126B indicating the overlapping occurrence range with “large intestine”.

Additionally, the threshold of each tissue may automatically be adjusted in accordance with the presence/absence of a disease of a patient, or the kind of disease. For example, in an area where stenosis of a blood vessel occurs, a pixel value becomes smaller than in a normal blood vessel, and the existence probability of a blood vessel becomes smaller in the case of a normal blood vessel. In addition, in a case where a patient has a cancer, there is a case in which a blood vessel deforms into a structure different from a structure of a normal blood vessel. In such an area, since the existence probability of a blood vessel becomes lower, it is difficult to determine “blood vessel” in the determination using the threshold of the default value. Thus, in regard to a medical image of a patient having stenosis or a cancer, by adjusting the threshold of a blood vessel to a smaller value, even an abnormal blood vessel occurring due to a disease can more easily be determined as a blood vessel, and the accuracy of segmentation can be enhanced.

Additionally, aside from the case of extracting tissues such as internal organs in a medical image, the configuration of the present embodiment may be applied to a case of extracting a bed or medical instrument appearing in a medical image and superimposedly displaying the extracted bed or medical instrument on the medical image. In this case, the processing circuitry 15 computes, by the computation function 151, an existence probability corresponding to a specific extraction target with respect to each of areas on a medical image, in regard to each of kinds of extraction targets, acquires, by the determination function 152, a plurality of thresholds that are set for the respective kinds of extraction targets, determines whether the area corresponds to the extraction target, based on the threshold and the existence probability, in regard to each of the areas and in regard to each of the kinds of extraction targets, and adjusts, by the adjustment function 154, the threshold in accordance with an input of the threshold. The extraction targets include a tissue such as an internal organ appearing on a medical image, and a medical instrument used for a therapy technique, a bed or the like appearing on a medical image.

According to at least one of the above-described embodiments, segmentation for a medical image can accurately be performed.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A medical information processing apparatus comprising processing circuitry, the processing circuitry being configured to:
compute a probability of correspondence to a specific extraction target with respect to each of areas on a medical image, in regard to each of kinds of extraction targets;
acquire a plurality of thresholds that are set for the respective kinds of the extraction targets, and determine whether the area corresponds to the extraction target, based on the threshold and the probability, in regard to each of the areas and in regard to each of the kinds of the extraction targets; and
adjust the threshold in accordance with an input of the threshold.

2. The medical information processing apparatus of claim 1, wherein the extraction target is tissue.

3. The medical information processing apparatus of claim 2, wherein the processing circuitry is configured to:
cause a display to display, based on a determination result of the area, a superimposition image in which a layer representing the area of the tissue is superimposed on the medical image; and
cause the display to display an input part that accepts an input of the threshold, update the determination result of the area in accordance with adjustment of the threshold by an operation of the input part, and update the display of the layer in accordance with the update of the determination result.

4. The medical information processing apparatus of claim 2, wherein the processing circuitry is configured to accept an input of a medical image, and to compute the probability in accordance with a trained model.

5. The medical information processing apparatus of claim 2, wherein the processing circuitry is configured to compute the probability based on a luminance value of the medical image.

6. The medical information processing apparatus of claim 2, wherein the processing circuitry is configured to issue a warning in a case where a difference between a luminance value of the area determined to correspond to the tissue and a reference value is large.

7. The medical information processing apparatus of claim 2, wherein the processing circuitry is configured to specify an overlapping area corresponding to a plurality of tissues, and to cause a display to display information relating to the overlapping area.

8. The medical information processing apparatus of claim 7, wherein the processing circuitry is configured to change, in a case where the overlapping area is specified at a time of setting a default value as the threshold, the threshold from the default value in such a manner that the overlapping area does not occur.

9. The medical information processing apparatus of claim 7, wherein the processing circuitry is configured to re-specify the overlapping area each time the threshold of the tissue changes, and to update the display of the information relating to the overlapping area.

10. The medical information processing apparatus of claim 7, wherein the processing circuitry is configured to accept selection of a tissue to be displayed on the overlapping area.

11. The medical information processing apparatus of claim 10, wherein the processing circuitry is configured to divide the overlapping area into a plurality of segments, to accept the selection of the tissue to be displayed, in regard to the segment including the tissue of a volume equal to or greater than a set value, and to display the tissue with the existence probability that is high, in regard to the segment including the tissue of a volume less than the set value.

12. The medical information processing apparatus of claim 10, wherein the processing circuitry is configured to divide the overlapping area into a plurality of segments, to accept the selection of the tissue in regard to the segment including the tissue of a volume equal to or greater than a set value, and to display the tissue having a high preset priority in regard to the segment including the tissue of a volume less than the set value.

13. A method comprising:
computing a probability that each of areas on a medical image corresponds to a specific extraction target with respect to a plurality of extraction targets;
acquiring a plurality of thresholds that are set for respective kinds of the extraction targets, and determining whether the area corresponds to the extraction target, based on the threshold and the probability, in regard to each of the areas and in regard to each of the kinds of the extraction targets; and
adjusting the threshold in accordance with an input of the threshold.

14. A non-transitory computer-readable storage medium storing a program for causing a computer to execute:
a function of computing a probability that each of areas on a medical image corresponds to a specific extraction target with respect to a plurality of extraction targets;
a function of acquiring a plurality of thresholds that are set for respective kinds of the extraction targets, and determining whether the area corresponds to the extraction target, based on the threshold and the probability, in regard to each of the areas and in regard to each of the kinds of the extraction targets; and
a function of adjusting the threshold in accordance with an input of the threshold.
